(19) United States
(12) Patent Application Publication
(10) Pub. No.: US 2025/0189692 A1
(43) Pub. Date: Jun. 12, 2025

(54) SYSTEM AND METHOD FOR DETECTING RADIO FREQUNCY (RF) EMITTING OBJECTS

(71) Applicants: Erik Blasch, Arlington, VA (US); Robert L. Ewing, WPAFB, OH (US); Oakland University, Rochester, MI (US)

(72) Inventors: Jia Li, Rochester, MI (US); Bing Liu, Rochester, MI (US); Huaizheng Mu, Rochester, MI (US); Shiyu Yang, Rochester, MI (US); Liangqi Yuan, Rochester, MI (US); Erik Blasch, Arlington, VA (US); Robert L. Ewing, WPAFB, OH (US)

(21) Appl. No.: 18/977,153

(22) Filed: Dec. 11, 2024

Related U.S. Application Data
(60) Provisional application No. 63/608,528, filed on Dec. 11, 2023.

(51) Int. Cl. G01V 8/00; G01V 8/10

(52) U.S. Cl. CPC G01V 8/005; G01V 8/10

(57) ABSTRACT

A system including at least one antenna configured to (i) receive radio frequency (RF) signals emitted from a region of interest (ROI) and (ii) receive RF signals from the ROI having an RF emitting object of interest (OOI) therein; and at least one computer readable storage medium including instructions. In an embodiment, the instructions may, inter alia, create a synthesized altered ROI RF signature based on an ROI RF signature and an unaltered OOI RF signature; compare the synthesized altered ROI RF signature with the altered ROI RF signature; and determine if the RF emitting OOI in the ROI is the same OOI that was within the shield environment based on the comparison of the synthesized altered ROI RF signature with the altered ROI RF signature. In other embodiments, the system can provide, inter alia, tracking information using RF signals. Methods of using RF signal reception are also disclosed.

### CROSS-REFERENCE TO RELATED APPLICATION

This application claims priority to U.S. Provisional Application 63/608,528, filed Dec. 11, 2023, the contents of which is incorporated herein by reference in its entirety.

### GOVERNMENT LICENSE RIGHTS

This invention was made with government support under FA9550-18-1-0287 and FA9550-21-1-0224 awarded by the U.S. Air Force Office of Scientific Research. The government has certain rights in the invention.

### FIELD OF TECHNOLOGY

Exemplary fields of technology for the present disclosure may relate to object detection such as, for example, human detection.

### BACKGROUND

The use of detection equipment to detect objects is carried out in many contexts. Often, detection equipment is deployed at public or private areas to detect humans, among other things. Public or private areas include, for example, residential structures, commercial structures (e.g., nursing homes), and any other area available for private or public use.

Detection equipment may include, for example, a transmitter and a receiver. The transmitter may send signals (e.g., electromagnetic (EM) signals) to an area of interest (e.g., into a room). The receiver may then be employed to receive EM signals that have reflected off objects (e.g., human(s)). The reflected signals may then be analyzed to determine the shape of the object(s). Reflected signals received over a timeframe may also be analyzed to determine movement of the object(s). However, as effective as these and other systems may be, each system may include shortcomings that need to be addressed.

For instance, it may be cost-prohibitive to deploy transmitters. Take, for example, a nursing home that may include a large number of rooms. The nursing home may have an interest in determining if patients are in their respective rooms. In such an example, however, the expenditure needed to deploy transmitters in relevant rooms may be significant.

In other instances, it simply may not be practical or feasible to deploy transmitters. Take, for example, police applications where there is a need to determine if there are one or more humans in a room and/or building, and/or to determine what the human(s) are doing in the room or building. If the room and/or building is not under control of the police, it may not be feasible or at least practical to install a transmitter in or near the room and/or building.

Accordingly, there is a need for systems and methods that overcome the difficulty in detecting objects and/or activities without implementing discrete transmitters.

### BRIEF DESCRIPTION OF THE DRAWINGS

FIG. 1A illustrates an exemplary technique for detecting an object-of-interest (OOI) and/or tracking the OOI;

FIGS. 2A-2C represent an exemplary visual representation of gathering neural network training data (e.g., frequency signatures);

FIG. 2D illustrates an exemplary computing device that may be employed to store and analyze training data;

FIG. 3A illustrates an exemplary implementation of an exemplary neural network;

FIG. 3B illustrates another exemplary implementation of another exemplary neural network;

FIG. 4 illustrates another exemplary technique for OOI detection;

FIG. 5 illustrates yet another exemplary technique for OOI detection;

FIG. 6 illustrates another exemplary OOI tracking technique; and

FIG. 7 illustrates an exemplary schematic of an exemplary neural network in training.

### DETAILED DESCRIPTION

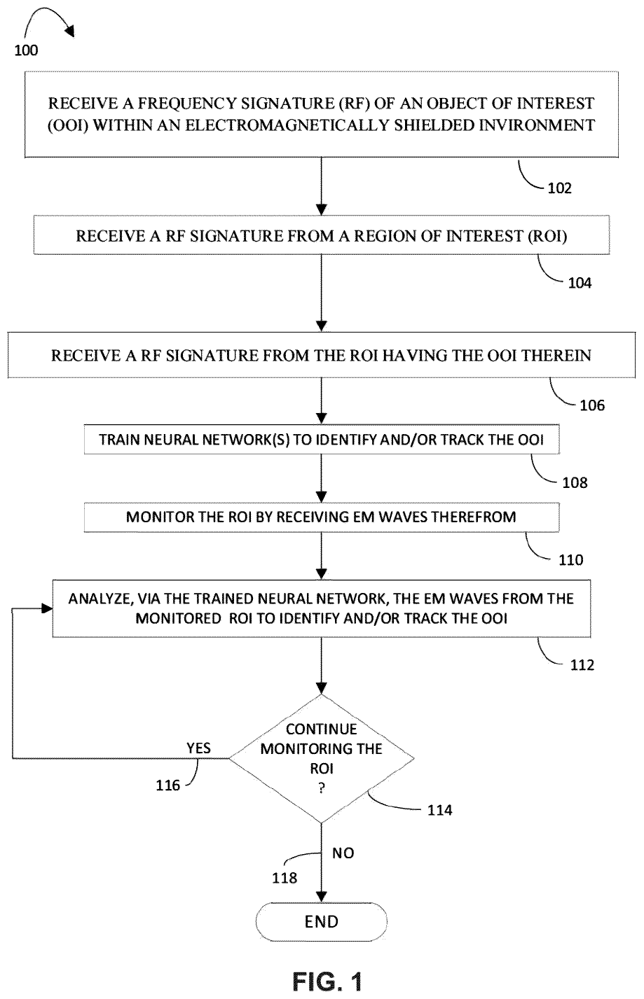

FIG. 1 illustrates an exemplary methodology or technique 100 for detecting an object that emits radio frequencies (RF). Process control may begin, e.g., at block 102, where a RF signature of an object of interest (OOI) within an electromagnetically shielded environment (e.g., a faraday cage) is received via a receiver (e.g., one or more antennae) and stored. The electromagnetically shielded environment shields, or at least substantially shields, the OOI (e.g., a human) from electromagnetic (EM) waves that originate outside the EM shielded environment. As such, since the OOI is in an EM shielded environment, it is understood that the RF signature received (e.g., at block 102) is associated with the OOI and not some other outside source. If, for example, the object is a human or some other animal, the receiver may be capable of receiving signals in the exemplary range of 1 megahertz (MHz) to 6 gigahertz (GHz). Other exemplary ranges may include a range from 400 MHz to 700 MHz. Still other ranges are contemplated that may depend on the RF spectrum the OOI emits. As used herein, the term “block” may signify or represent a stage or step associated with the disclosure.

After receiving the OOI RF signature (e.g., at block 102), process control proceeds, e.g., to block 104, where a RF signature of a region of interest (ROI) without the OOI therein is gathered. As such, this RF signature is associated with the ROI, but not with the OOI, thus being an environmental RF signature. The ROI may include, for example, a building structure (e.g., walls, floor, and ceiling) and any object (e.g., room furnishings) and etc. therein. For the purpose of discussion, the ROI RF signature can be considered the environmental baseline RF of the ROI.

It is noted that a transmitter is not employed when gathering RF signatures from the OOI (e.g., block 102) or from the ROI (e.g., block 104). Accordingly, these are passive RF signatures in that they are not the result of actively transmitting EM waves at the OOI and the ROI to produce reflected waves.

With reference to FIG. 1, after the OOI and ROI RF signatures are gathered, process control proceeds (e.g., to block 106) and an RF signature is gathered from the ROI having the OOI therein. Accordingly, this RF signature is associated with the OOI as well as the ROI (i.e., an OOI/ROI RF signature). As such, this RF signature may be considered an environmental RF signature altered by the OOI.

While FIG. 1 represents that the OOI RF signature is gathered from the EM shielded environment (e.g., block 102) before gathering the ROI RF signature (e.g., block 104), which in turn is gathered prior to receiving the RF signature from the ROI having the OOI therein (e.g., block 106), other exemplary techniques may change the order in which each RF signature is gathered.

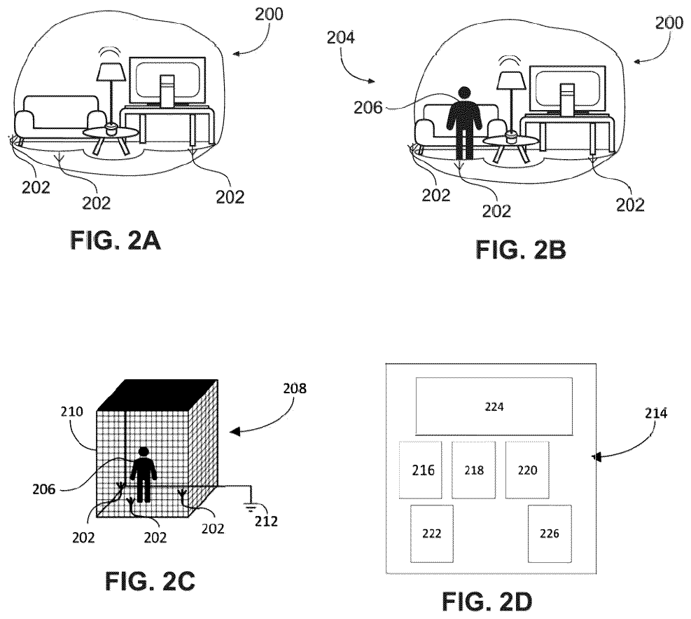

With continued reference to FIG. 1, after the environmental RF signature(s) altered by the OOI is received (e.g., the block 106 RF signature), process control may proceed (e.g., to block 108) where two or more received RF signatures (e.g., blocks 102-106) are used to train a neural network to track and/or identify the OOI. Further details regarding training a neural network to identify and/or track the OOI will be set forth below with respect to FIGS. 2A-7.

With continued reference to FIG. 1, once the neural network is trained for OOI tracking and/or identification, the ROI may be monitored (e.g., at block 110). Monitoring the ROI may include receiving EM waves (e.g., RF waves) therefrom. While the ROI is monitored, process control proceeds (e.g., to block 112) and the trained neural network analyzes the EM waves from the monitored ROI to identify and/or track the OOI. Details regarding the trained neural network's analysis of the EM waves received from the monitored ROI will be set forth below with respect to FIGS. 2A-7.

At a decision point (e.g., block 114 of FIG. 1), process control can determine whether or not to continue monitoring the ROI. The decision may be based, at least in part, on a user input or some other specified factor.

If it is determined that the monitoring of the ROI will continue 116, process control may proceed back (e.g., to block 112) and technique 100 continues. Alternatively, if it is determined that monitoring will not continue 118, process control proceeds to an end.

Attention is now directed to FIGS. 2A-2C. FIGS. 2A-2C represent an exemplary visual representation of gathering neural network training data (RF signatures). FIG. 2A illustrates an exemplary unoccupied unshielded environment (i.e., a ROI) 200, where baseline spectrums (e.g., an RF signature) of the environment are collected via antennae 202 (a.k.a. EM receiver(s)). The EM signals received from the unshielded ROI via the antennae 202 may be referred to as the baseline environmental RF (ENV-RF).

While three exemplary antennae 202 are shown in FIG. 2A, as well as FIGS. 2B-2C, other examples may include a different number of antennae (e.g., one, two, or more than three). The antennae may be capable of receiving a wide range of EM signals. For example, the range may be from 1 megahertz (MHz) to 6 gigahertz (GHz). Other exemplary ranges may include a range from 400 MHz to 700 MHz. Still other ranges are contemplated that may depend on the RF signatures produced by the OOI as well as by the ROI.

FIG. 2B illustrates an exemplary occupied unshielded environment 204 having an OOI therein. The environment 204 includes the ROI 200 of FIG. 2A, but further includes an exemplary OOI (e.g., human 206) therein. In this example, since the object is the human 206, the EM waves received via the antennae 202 represent a human altered environmental RF (HALE-RF) signature. Effectively, the human 206 alters the baseline of the spectrum received in the unoccupied environment 200 of FIG. 2A.

FIG. 2C illustrates an exemplary occupied EM shielded environment 208 shielded by EM shielding 210. The EM shielding 210 may, for example, be an electrically grounded 212 conductive enclosure. The EM shielded environment 208 allows for high signal-to-noise ratio (SNR) human RF signatures to be collected via one or more antennae 202. It is noted that the antennae 202 shown in FIGS. 2A-2C need not be the same antennae. That is, the antennae 202 employed in the ENV-RF environment 200 of FIG. 2A may be different than the antennae 202 employed in the HALE-RF environment 204 of FIG. 2B, which in turn may be different than the antennae 202 employed in the EM shielded environment of FIG. 2C.

With continued reference to FIG. 2C, EM shielding 210 may be comprised of a variety of materials effective at shielding the antennae 202 from EM signals other than EM signals from the human 206. For example, the EM shielding 210 could be a metallic netting, a thin layer of sheet metal, metal screening, or other material that electromagnetically isolates the human 206 from the environment outside the shielding. Regardless of the material employed for the EM shielding 210, the EM signals received in the EM shielded environment 208 can be referred to as human RF (H-RF) signatures. Different people can emit different RF signatures.

FIG. 2D illustrates an exemplary computational system 214 that employs RF signatures (e.g., ENV-RF, HALE-RF, and H-RF) gathered in the different environments (see FIGS. 2A-2C) to train one or more neural networks so that the information contained in the RF signatures can be extracted for a variety of applications.

The exemplary computational system 214 may include one or more software defined radios (SDRs) 216, one or more processors 218, memory 220, storage 222, as well as a screen 224 and input hardware 226.

The SDR(s) 216 may, for example, be comprised of one or more universal serial busses (USBs) that plug into the computational system 214 or, for example, be embedded into the computational system 214. The instantaneous bandwidth and frequency may, for example, be controlled through opensource software where, for example, 8-bit quadrature samples may be recorded. The frequency band of antenna 202 and any corresponding cables may be matched to the frequency range to be scanned by the SDR(s) 216. As noted above, the computational system 214 of FIG. 2D is merely exemplary and other computational systems may be employed.

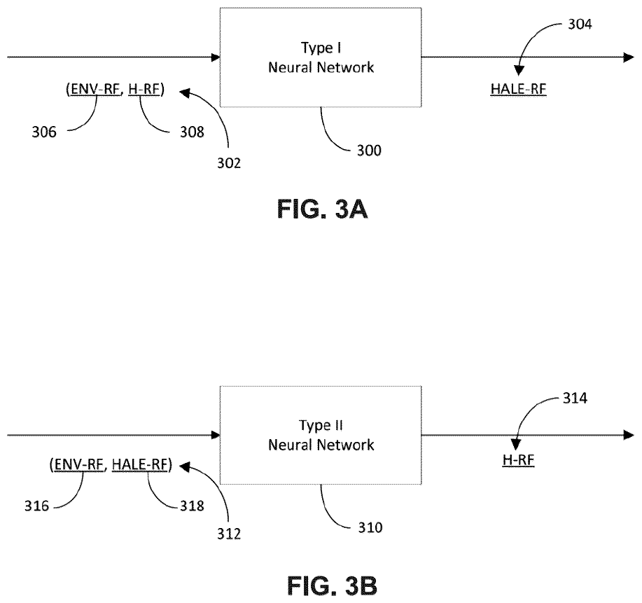

Referring now to FIGS. 3A and 3B, implementation of two exemplary neural networks are illustrated. With respect to FIG. 3A, an exemplary Type 1 neural network 300, a paired Type I input 302, and a Type I target output 304 are shown. The paired input 302 includes a first Type I input 306 and a second Type I input 308. The Type I neural network 300 models the interaction between an RF emitting object (see, e.g., human 206 of FIGS. 2B and 2C) and an existing RF field in a ROI (see, e.g., ENV-RF discussed above with respect to FIG. 2A) and synthesizes spectrum samples of an object altered EM field (see, e.g., HALE-RF discussed above with respect to FIG. 2B).

During training, the spectrum samples of the first Type I input 306 (e.g., ENV-RF) and the second Type I input 308 (e.g., H-RF) may be paired as the input 302 to the Type I neural network 300 and the neural network 300 works to use the paired input 302 to create or synthesize the target output 304 (e.g., a synthesized HALE-RF).

As will be appreciated, the Type I neural network 300 models how RF emitting objects such as humans alter the EM field of an environment (e.g., a ROI). An exemplary system may include at least one antenna (e.g., the antenna 202 of FIG. 2A) and a neural network (e.g., the Type I neural network 300 of FIG. 3A). The at least one antenna may be configured to (i) receive radio frequency (RF) signals emitted from a region of interest (ROI) such that a ROI RF signature (e.g., ENV-RF) may be obtained. The neural network may synthesize an altered ROI RF signature (e.g., a synthesized HALE-RF) based on the ROI RF signature and an object of interest (OOI) RF signature (e.g., H-RF).

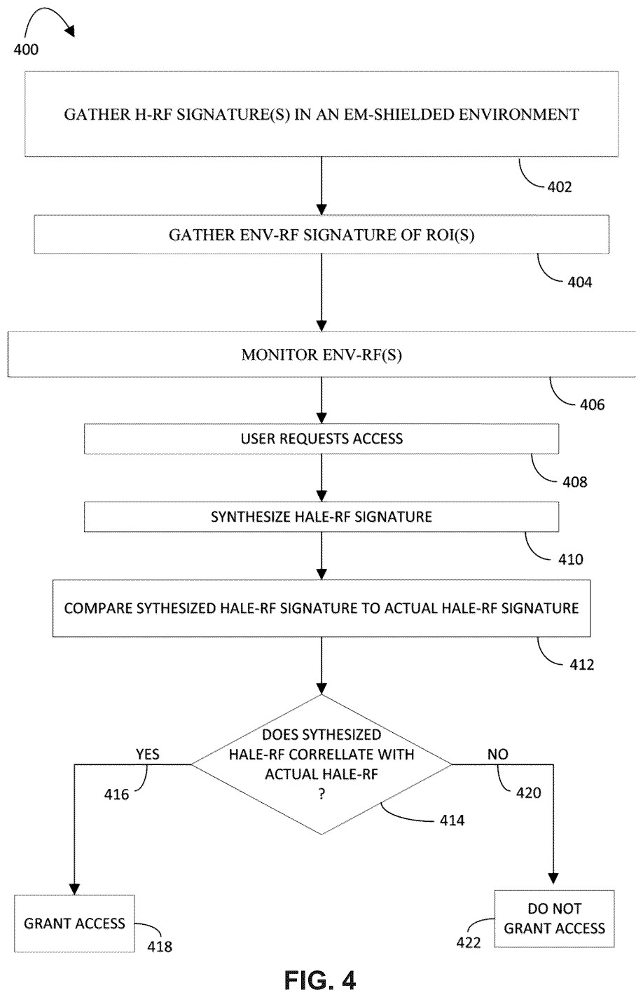

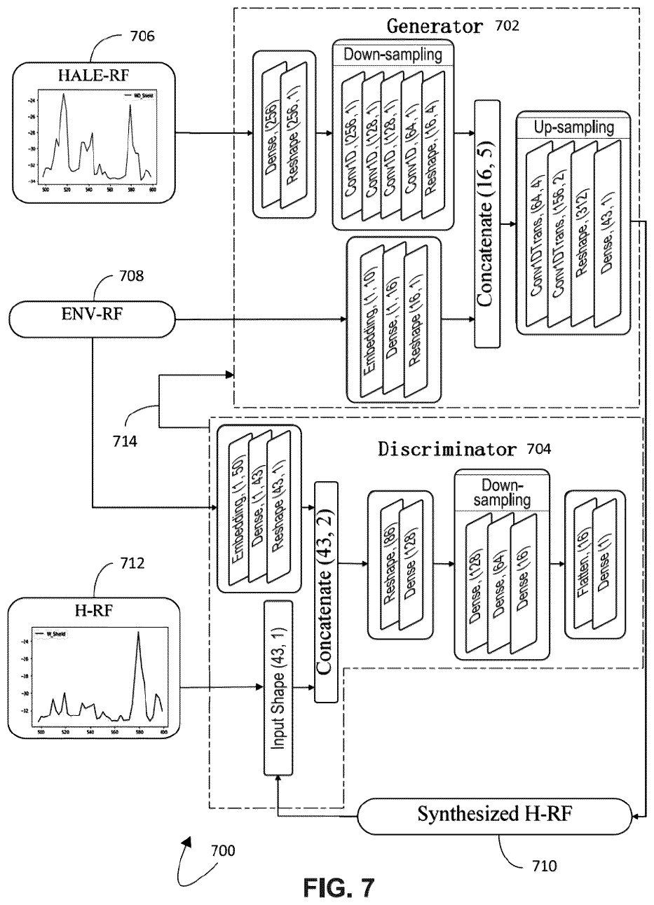

Further details regarding exemplary Type I neural networks will be set forth below with respect to FIGS. 4 and 7.

With reference now to FIG. 3B, an exemplary Type II neural network 310, a Type II paired input 312, and a Type II target output 314 are shown. The paired input 312 of FIG. 3B includes a first Type II input 316 and a second Type II input 318. In the example shown, the first Type II input 316 includes an ENV-RF signature and the second Type II input 318 includes HALE-RF signature. Effectively, once trained, the Type II neural network 310 removes the environmental RF baseline signature (i.e., ENV-RF) from the object (e.g., human) altered environmental spectrum (i.e., HALE-RF signature) to synthesize a high SNR object RF signature (i.e., the target output 314).

During the training phase, the spectrum samples of ENV-RF 316 and HALE-RF 318 may be paired as the input 312 to the Type II neural network 310 and the neural network 310 may synthesize a H-RF signature (i.e., target output 314).

An exemplary system may, for example, include at least one antenna (e.g., antenna 202 of FIG. 2A) configured to (i) receive radio frequency (RF) signals emitted from a region of interest (ROI) such that a ROI RF signature (e.g., ENV-RF) may be obtained and (ii) receive RF signals from the ROI having an RF emitting object of interest (OOI) therein such that an altered ROI signature (e.g., HALE-RF) may be obtained. The neural network 310 (e.g., the Type II neural network of FIG. 3B) may be configured to synthesize an OOI RF signature (e.g., synthesized H-RF) based on the ROI RF signature and the altered ROI RF signature.

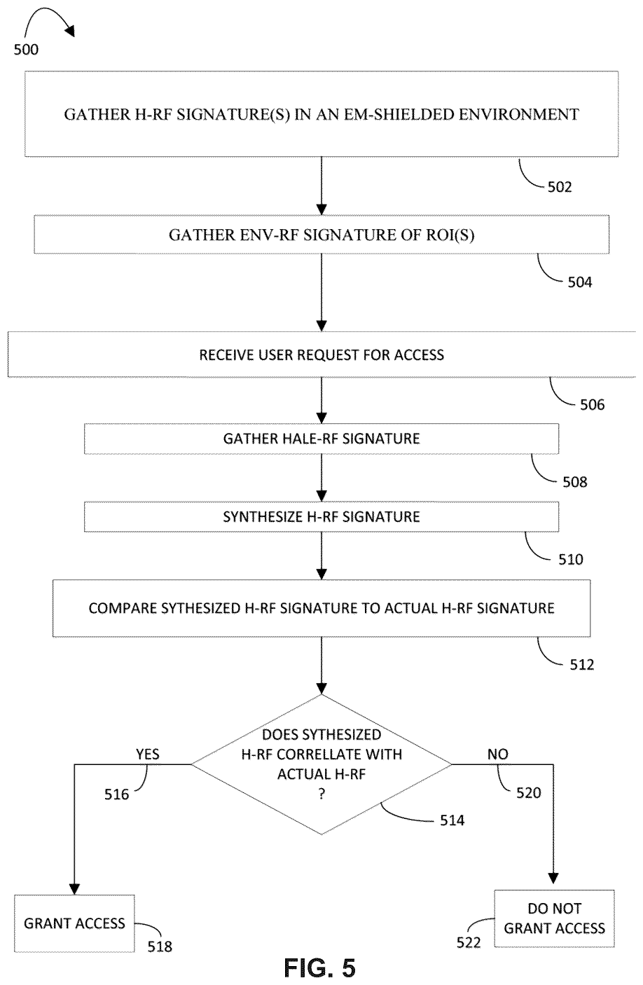

The Type II neural network 310 may be used to model a digital EM shield to remove the environmental factor and provide the capability to acquire high SNR human radio frequency signature without using a physical EM shield. Further details will be set forth below with respect to FIGS. 5-7.

While humans are used as the exemplary OOI with regard to the discussion of FIGS. 3A and 3B above, as well as the remaining figures discussed below, a different object could instead be the OOI. As mentioned above, the system(s) and technique(s) discussed herein are effective at identifying and/or tracking an object that emits EM waves (e.g., produces an RF-signature) that may be received by a receiver. Accordingly, the techniques and systems described herein need not employ transmitters employed to bounce EM waves off the OOI for tracking and/or identification.

The Type I neural network 300 of FIG. 3A may be employed for a variety of tasks. For example, the Type I neural network 300 may be employed as an authentication system. An exemplary technique 400 for such an authentication system is shown in FIG. 4.

Process control may begin, for example, at block 402 where H-RF signatures may be individually gathered from one or more users. Such signatures may, for example, be gathered in an EM-shielded environment as shown in FIG. 2C. Process control may then proceed (e.g., to block 404 of FIG. 4) where an ENV-RF signature of an ROI may be gathered. In other words, an environmental baseline RF of a ROI without any humans may be gathered. If multiple locations will be employing authentication protocols, multiple environmental baseline RF signatures (i.e., multiple ENV-RFs) may be gathered. As such, an ENV-RF signature may be gathered from each ROI involved in the authentication protocols.

While exemplary technique 400 shows that object RF signature(s) (e.g., H-RF(s)) may be gathered 402 prior to gathering the environmental baseline signature(s) (ENV-RF(s)) of the ROI 404, other exemplary techniques may gather the ENV-RF signature(s) and the H-RF signature(s) at the same time, or the ENV-RF signature(s) may be gathered before the one or more object RF signature(s) (e.g., H-RF(s)) may be gathered.

With continued reference to FIG. 4, the technique 400 further includes monitoring the environmental RF baseline (see, e.g., FIG. 2A) of the ROI(s) (e.g., at block 406).

In embodiments, at a stage or point (e.g., block 408), a user within at least one ROI may request access to a building, room, or other area. Alternatively, general detection of a person may serve as a de facto access request. Whether access is requested by a user or if access request is based on another factor, after requesting access, the user's previously obtained H-RF signature and the previously obtained ENV-RF of the ROI (i.e., RF signature of the ROI without the user present) may be fed into the trained Type I neural network. The Type I neural network may then create a synthesized HALE-RF signature (e.g., at block 410).

Process control may then proceed (e.g., to block 412), where the synthesized HALE-RF signature may be compared to an actual HALE-RF signature (monitored HALE-RF reading). At a decision phase or point (e.g., block 414), process control may determine if the synthesized HALE-RF signature effectively correlates with the actual HALE-RF signature. For example, if the synthesized HALE-RF signature effectively correlates 416 with the actual HALE-RF signature (e.g., the correlation is greater than a preset threshold), process control may proceed (e.g., to block 418) and access may be granted to the user.

Alternatively, if the synthesized HALE-RF signature does not effectively correlate 420 with the actual HALE-RF signature (e.g., the correlation is less than or equal to the preset threshold), process control may proceed (e.g., to block 422) and access may not be granted to the user.

As discussed in the example above, the Type I neural network 300 of FIG. 3A may be employed for a variety of applications, such as for an authentication system. Similarly, the Type II neural network 302 of FIG. 3B may also be employed for a variety of tasks. For example, the Type II neural network 302 may also be employed as an authentication system. An exemplary technique 500 for such an authentication system is shown in FIG. 5.

In embodiments, process control may begin, for example, at block 502 where H-RF signature(s) are individually gathered from one or more users. Such signatures may, for example, be gathered in an EM shielded environment as shown in FIG. 2C. After gathering the H-RF signature(s), process control may then proceed (e.g., to block 504) where ENV-RF signature(s) of ROIs may be gathered. In other words, an environmental baseline RF of each ROI without any humans may be individually gathered. If the authentication system will be employed in more than one ROI (e.g., several rooms in a building), a unique ENV-RF signature for each ROI would be gathered via one or more antennae.

While exemplary technique 500 shows that user RF signatures (i.e., H-RF signatures) may be gathered 502 prior to gathering the environmental baseline (ENV-RF signature) of the ROI 504, other exemplary techniques may gather the ENV-RF signature(s) and the H-RF signature(s) at the same time, or the ENV-RF signature(s) may be gathered before the one or more H-RF signature(s) may be gathered.

With continued reference to FIG. 5, after the H-RF signature(s) and ENV-RF signature(s) may be gathered, process control may continue (e.g., to block 506) where a user request for access to an ROI may be received. Once the user request for access is received, process control may continue (e.g., to block 508) and a HALE-RF signature may be gathered by one or more antennae. That is, an RF signature of the respective ROI having the user therein may be gathered or acquired.

Once the HALE-RF signature is received, the previously obtained ENV-RF signature of the relevant ROI (i.e., RF signature of the ROI without the user present) and the HALE-RF signature may be fed into a trained Type II neural network in order to synthesize a H-RF signature of the user (e.g., at block 510). The Type II neural network effectively removes the environmental baseline (i.e., ENV-RF) from the altered environmental spectrum (i.e., HALE-RF) to recover a synthesized SNR human RF signature (e.g., at block 510).

Process control may then proceed (e.g., to block 512), where the synthesized H-RF signature may be compared to an actual H-RF signature (or a database of human RF signatures). At a decision stage or point (e.g., block 514), process control may determine if the synthesized H-RF signature effectively correlates with an actual H-RF signature. For example, if the synthesized H-RF signature effectively correlates 516 with the actual H-RF signature (e.g., the correlation is greater than a preset threshold), process control may proceed (e.g., to block 518) and access may be granted to the user.

Alternatively, if the synthesized H-RF signature does not effectively correlate 520 with any of the actual H-RF signatures (e.g., the correlation is less than or equal to the preset threshold), process control may proceed (e.g., to block 522) and access may not be granted to the user.

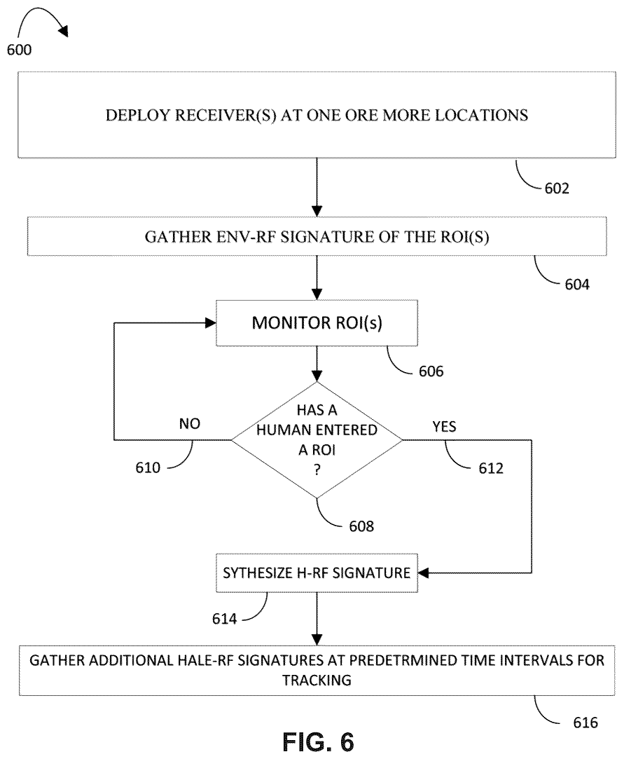

In addition to being employed for authentication systems, the Type II neural network may also be employed as a tracking system. FIG. 6 illustrates an exemplary tracking technique 600 using a Type II neural network (e.g., the Type II Neural Network 310 of FIG. 3B). Process control may begin (e.g., at block 602 of FIG. 6) where receiver(s) (e.g., antenna(s)) may be deployed at one or more locations (i.e., ROI(s)). Proceeding then (e.g., to block 604), the environmental baseline (i.e., ENV-RF signature) may be determined at each of the one or more locations via the receiver(s). The ENV-RF signature at each location may differ.

At a phase or point (e.g., block 606), each of the one or more locations may be monitored for a human or other object. The monitoring may be carried out in a variety of ways. For example, a motion detector may be employed to detect movement in the one or more locations. As another example, the ENV-RF signature may be monitored for disturbances, thus indicating that someone or something has entered the monitored location. Other monitoring techniques may also be employed.

At a decision phase or point (e.g., block 608), process control may determine if a human or other object has entered one of the one or more locations. If a human or other object has not entered 610 any of the locations, process control may proceed back (e.g., to block 606) and continue to monitor the one or more locations.

If, on the other hand, it is determined that a human or other object has entered 612 one of the one or more locations, process control may proceed (e.g., to block 614) and a synthesized H-RF signature may be determined. The synthesized H-RF signature may be determined by gathering a HALE-RF signature of the relevant ROI and inputting the HALE-RF signature along with the respective ENV-RF signature (see e.g., block 604) into a Type II neural network (e.g., the Type II neural network 310 of FIG. 3B). In other words, the local ENV-RF signature (i.e., the ENV-RF signature of the location where the human or object was detected) and the HALE-RF signature may be fed into the trained Type II neural network to acquire or synthesize a high SNR H-RF signature of the subject or object (a.k.a., synthesized H-RF).

Upon synthesizing the H-RF signature, process control may continue (e.g., to block 616) where additional HALE-RF signatures may be acquired at predetermined time intervals to track the human or object. Since each additional HALE-RF signature and respective ENV-RF signature may be fed into the Type II neural network to synthesize additional respective H-RF signatures, each additional synthesized H-RF signature can be compared to the originally synthesized H-RF to ensure the same human or object is being tracked.

It is noted that since the H-RF signature may be synthesized using the respective HALE-RF signature and ENV-RF signatures in the exemplary technique 600 of FIG. 6, there is no need to acquire an actual H-RF signature from a human or object in an EM shielded room (see., e.g., FIG. 2C). If, however, an EM-shielded H-RF signature was previously obtained from one or more humans or other objects, the synthesized H-RF signatures, discussed with respect to FIG. 6, may be compared to a database of EM-shielded H-RF signatures to identify the human or object being tracked. That is, a person may be identified if the synthesized H-RF signature correlates with a previously stored EM-shielded H-RF signature. The correlation need not be exact, but rather may come within a predetermined threshold.

Among other things, the exemplary technique 600 of FIG. 6 may be employed in smart building management for automatic control of the building's HVAC, lighting, and/or other interrelated systems. Further, the technique 600 may be integrated with an authentication system (e.g., see FIGS. 4 and 5) to enhance security.

Since the exemplary systems and techniques of FIGS. 1-6 may passively collect RF spectrum (i.e., does not employ an EM transmitter), the system and techniques do not interfere with the communication functionality of existing wireless signals (e.g., Wi-Fi, cellular, or other wireless signals). Such systems and/or techniques may have a relatively low cost and energy expenditure since EM transmitters, which may be expensive and/or consume significant energy, are not employed. Accordingly, the techniques and systems discussed herein may achieve human body sensing by utilizing only receivers, potentially avoiding the need for expensive transmitters that can cost thousands of dollars and consume significant energy.

These systems and/or techniques may also be resistant to intercepts since there are no transmitted EM signals to intercept. Accordingly, such systems and/or techniques may also be resistant to hacking.

While humans have been used as an exemplary OOI in the discussion of the systems and techniques described herein, variations of the systems and techniques employed may tailored to other OOIs that emit an RF or EM signature. For example, animals instead of humans may be tracked or identified. Alternatively, robot devices that have an RF or EM signature may also serve as the OOI.

Referring now to FIG. 7, an exemplary schematic of neural network training is shown. The schematic illustrates a Type II neural network 700 (e.g., a conditional generative adversarial network (CGAN)) that includes a generator 702 and a discriminator 704. Training begins by inputting a HALE-RF signature 706 and an ENV-RF signature 708 into the generator 702 of the Type II neural network 700. By using HALE-RF signature 706 and the ENV-RF signature 708, the generator 702 generates a synthesized H-RF signature 710 that may be fed to the discriminator 704.

Next, the discriminator 704 employs the ENV-RF signature 708 and an H-RF signature 712 (i.e., an actual RF signature received from the human in an EM shielded environment) to evaluate the synthesized H-RF signature 710. In an alternate example, the ENV-RF signature need not be fed to the discriminator 704 to evaluate the synthesized H-RF signature 710.

Referring back to FIG. 7, the discriminator 704 effectively employs the ENV-RF signature 708 and the H-RF signature 712 to ensure that environmental RF signatures are not in the synthesized H-RF signature 710. Upon evaluating the synthesized H-RF signature 710 and the actual H-RF signature 712, the discriminator 704 feeds a score 714 to the generator 702. The score 714 could be based on, for example, a least mean square technique, a cross-correlation technique, or other cost function.

If the score 714 does not meet a preset criteria, the generator 702 iterates and synthesizes another H-RF signature 710, which is again evaluated by the discriminator 704. This continues until the score 714 at least meets an established or preset criteria.

It is noted that the condition data dimensions shown in FIG. 7 may be designed to be changed based on the complexity of the environment and subject categories.

Though not shown, a similar training technique may be employed in a Type I neural network. For example, instead of inputting the HALE-RF signature 706 and the ENV-RF signature 708 into the generator 702 to generate the synthesized H-RF signature 710, the ENV-RF signature and H-RF signature could be input into the generator to generate a synthesized HALE-RF signature, which in turn may be compared to an actual HALE-RF signature by the discriminator to create a score.

With regard to the processes, techniques, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Accordingly, reference now back to FIGS. 1-7 discussed above, exemplary system(s) and devices (e.g., computational system 214 of FIG. 2D) may be any computing system and/or device that includes a processor (e.g., processor(s) 218) and a memory (e.g., memory 222). Computing systems and/or devices generally include computer-executable instructions, where the instructions may be executable by one or more computing devices (214) such as those listed above and below. Computer-executable instructions may be compiled or interpreted from computer programs created using a variety of programming languages and/or technologies, including, without limitation, and either alone or in combination, Java™, C, C++, Visual Basic, Java Script, Perl, etc. The exemplary system(s), device(s), and items therein may take many different forms and include multiple and/or alternate components. While exemplary systems, devices, and modules are shown in the Figures, the exemplary components illustrated in the Figures are not intended to be limiting. Indeed, additional or alternative components and/or implementations may be used, and thus the above examples should not be construed as limiting.

In general, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OS X and iOS operating systems distributed by Apple Inc. of Cupertino, California, the BlackBerry OS distributed by Research In Motion of Waterloo, Canada, and the Android operating system developed by the Open Handset Alliance. Examples of computing systems and/or devices include, without limitation, personal computers, cell phones, smart-phones, super-phones, tablet computers, next generation portable devices, handheld computers, secure voice communication equipment, or some other computing system and/or device.

Further, the processor or the microprocessor of computing systems and/or devices receives instructions from the memory and executes these instructions, thereby performing one or more processes, including one or more of the processes described herein. Such instructions and other data may be stored and transmitted using a variety of computer-readable mediums (e.g., memory 220).

A CPU or processor may include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the processor(s) 218 of FIG. 2D may be any one of, but not limited to single, dual, triple, or quad core processors (on one single chip), graphics processing units, visual processing units, and virtual processors.

Memory (e.g., memory 220) may be, in general, any computer-readable medium (also referred to as a processor-readable medium) that may include any non-transitory (e.g., tangible) medium that participates in providing data (e.g., instructions) that may be read by a computer. Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of terms such as “first,” “second,” “third,” and the like that immediately precede an element(s) do not necessarily indicate sequence unless set forth otherwise, either explicitly or inferred through context.

What is claimed is:

1. A system comprising:
at least one antenna configured to (i) receive radio frequency (RF) signals emitted from a region of interest (ROI) such that a ROI RF signature is obtained; (ii) receive RF signals from the ROI having an RF emitting object of interest (OOI) therein such that an altered ROI RF signature is obtained; and (iii) receive RF signals from an OOI within a shielded environment such that a generally unaltered OOI RF signature is obtained; and
at least one computer readable storage medium having instructions stored thereon to:
create a synthesized altered ROI RF signature based on the ROI RF signature and the unaltered OOI RF signature;
compare the synthesized altered ROI RF signature with the altered ROI RF signature; and
determine if the RF emitting OOI in the ROI is the same OOI that was within the shield environment based on the comparison of the synthesized altered ROI RF signature with the altered ROI RF signature.

2. The system of claim 1 wherein the RF signals received from the OOI within the shield environment are not reflected RF signals.

3. The system of claim 2 wherein the at least one antenna configured to receive the RF signals from the OOI in the shielded environment is different than the at least one antenna configured to receive the RF signals from the ROI having the RF emitting OOI therein.

4. The system of claim 3 wherein the RF emitting OOI within the ROI and the OOI within the shield environment is a human.

5. The system of claim 1 further comprising a neural network configured to (i) receive the ROI RF signature and the unaltered OOI RF signature and (ii) carry out the creation of the synthesized altered ROI RF signature based on the ROI RF signature and the unaltered OOI RF signature.

6. The system of claim 5 wherein the neural network is a conditional generative adversarial network (CGAN).

7. The system of claim 4 wherein the at least one computer readable storage medium has further instructions stored thereon to grant the RF emitting OOI in the ROI access to a room when it is determined that the RF emitting OOI in the ROI is the same OOI that was within the shielded environment.

8. A system comprising:
at least one antenna configured to: (i) receive radio frequency (RF) signals emitted from a region of interest (ROI) such that a ROI RF signature is obtained and (ii) receive a first set of RF signals emitted from the ROI having an object of interest (OOI) therein such that an altered ROI RF signature is obtained; and
at least one computer readable storage medium having instructions stored thereon to:
create a first synthesized OOI RF signature based on the ROI RF signature and the altered ROI RF signature, wherein the first set of RF signals emitted from the ROI having the OOI therein is received during a first time period;
create a second synthesized OOI RF signature based on a second ROI RF signature and a second altered ROI signature, wherein the second altered ROI RF signature is based on a second set of RF signals emitted from a second ROI having the OOI therein at a second time period, and wherein the second ROI RF signature is based on RF signals emitted from a second ROI;
determine that the first synthesized OOI RF signature is substantially the same as the second synthesized OOI RF signature; and
provide tracking information to a user based on the determination that the first synthesized OOI RF signature is substantially the same as the second synthesized OOI RF signature, wherein the tracking information identifies a first location of the OOI during the first time period and a second location of the OOI during the second time period.

9. The system of claim 8 wherein the at least one antenna is further configured to receive RF signals from the OOI in an electromagnetic (EM) shielded environment such that an OOI RF signatured is obtained, wherein the OOI emits RF signals and the RF signals from the OOI in the EM shielded environment are free of RF signals reflected off of the OOI.

10. The system of claim 9 wherein the OOI is a human.

11. The system of claim 8 wherein the first synthesized OOI RF signature and the second synthesized OOI RF signature is further based on the OOI RF signature.

12. The system of claim 8 further comprising a neural network configured to (i) receive the ROI RF signature and the altered ROI RF signature and (ii) carry out the creation of the synthesized OOI RF signature based on the ROI RF signature and the altered ROI RF signature.

13. The system of claim 12 wherein the neural network is a conditional generative adversarial network (CGAN).

14. A method comprising:
receiving, via at least one antenna, radio frequency (RF) signals from a region of interest (ROI) to obtain a ROI RF signature, wherein the ROI RF signature represents the ROI without an object of interest (OOI) therein;
receiving, via the at least one antenna, RF signals from the ROI to obtain an altered ROI RF signature, wherein the altered ROI RF signature represents the ROI having the OOI therein;
synthesizing, via a neural network, a first synthesized OOI RF signature, wherein the first synthesized OOI RF signature is based on the altered ROI RF signature and the ROI RF signature;
synthesizing, via the neural network, a second synthesized OOI RF signature, wherein the second synthesized OOI RF signature is based on a second altered ROI RF signature and a second ROI RF signature;
determining, via at least one processor, that the first synthesized OOI RF signature is substantially the same as the second synthesized OOI RF signature; and
providing tracking information to a user based on the determining that the first synthesized OOI RF signature is substantially the same as the second synthesized OOI RF signature, wherein the tracking information identifies a first location of the OOI during a first time period and a second location of the OOI during the second time period.

15. The method of claim 14 further comprising receiving RF signals from the OOI in an electromagnetic (EM) shielded environment such that an OOI RF signatured is obtained, wherein the OOI emits RF signals and the RF signals from the OOI in the EM shielded environment are free of RF signals reflected off of the OOI, and wherein the OOI is a human.

16. The method of claim 14 wherein the neural network is a conditional generative adversarial network (CGAN).

17. A method comprising:
receiving, via one or more antenna, region of interest (ROI) radio frequency (RF) signals to obtain a ROI RF signature, wherein the ROI RF signature represents the ROI without an object of interest (OOI) therein;
receiving, via the one or more antenna, an altered ROI RF signature, wherein the altered ROI RF signature represents the ROI having the OOI therein;
synthesizing, via a neural network, a first synthesized altered ROI RF signature, wherein the first synthesized altered ROI signature estimates an RF signature of the ROI having the OOI therein, wherein synthesizing the first synthesized altered ROI RF signature is based on the ROI RF signature and a first OOI RF signature, wherein the first OOI RF signature is based on RF signals emitted from the OOI in a shielded environment such that the OOI is not reflecting RF signals;
comparing, via one or more processors, the first synthesized ROI RF signature the altered ROI RF signature; and
determining, via the one or more processors, that the OOI in the ROI is the same OOI that was within the shield environment based on the comparison of the first synthesized altered ROI RF signature with the altered ROI RF signature.

18. The method of claim 17 wherein the OOI is a human.

19. The method of claim 17 further comprising granting the OOI in the ROI access to a room, wherein the granting the OOI in the ROI access to the room is based on the determining that the OOI in the ROI is the same OOI that was within the shield environment

20. The method of claim 17 wherein the neural network is a conditional generative adversarial network (CGAN).
